(19) United States
(12) Patent Application Publication
(10) Pub. No.: US 2016/0096700 A1
(43) Pub. Date: Apr. 7, 2016

(54) SHEET PROCESSING APPARATUS, METHOD FOR CONTROLLING THE SAME, AND STORAGE MEDIUM

(71) Applicant: CANON KABUSHIKI KAISHA, Tokyo (JP)

(72) Inventor: Ayumi Suzuki, Kawasaki-shi (JP)

(21) Appl. No.: 14/875,465

(22) Filed: Oct. 5, 2015

(30) Foreign Application Priority Data
Oct. 7, 2014 (JP) 2014-206741

(51) Int. Cl. B65H 37/04; G03G 15/00

(52) U.S. Cl. CPC B65H 37/04; G03G 15/6541

(57) ABSTRACT

The present invention is directed to selectively switching binding processing according to a remaining amount of consumable materials required for the binding processing even in a case where the binding processing for binding sheets by using consumable materials is specified. To achieve this purpose, a sheet processing apparatus includes a first binding unit configured to bind sheets by using a consumable material, a second binding unit configured to bind sheets without using the consumable material, and a control unit configured to control the sheet processing apparatus to perform binding processing on sheets by using the first or the second binding unit, wherein the control unit determines whether to perform the binding processing by using the first binding unit or by using the second binding unit according at least to a remaining amount of the consumable materials.

### BACKGROUND OF THE INVENTION

1. Field of the Invention

The present invention relates to a sheet processing apparatus configured to perform binding processing on a plurality of sheets with an image printed thereon.

2. Description of the Related Art

In recent years, there has been an image processing apparatus capable of binding sheets by specifying either binding processing for binding sheets by using a staple (or staples) or binding processing for binding sheets without using a staple (see Japanese Patent Application Laid-Open No. 2013-170066).

The binding processing for binding sheets by using a staple requires staples as consumable materials. Therefore, if staples are not set or if staples run out, the binding processing cannot be performed until staples are replenished.

Methods for binding sheets without using a staple include a method for pressing special blades onto the sheets to hold the binding sheets together. Such binding processing for binding sheets without using a staple does not require consumables such as staples, and therefore enables performing the binding processing without caring consumable materials. However, the binding processing for binding sheets without using a staple provides an upper-limit number of bindable sheets smaller than that by the binding processing for binding sheets by using a staple.

In an image processing apparatus discussed in Japanese Patent Application Laid-Open No. 2013-170066, a user who wants to bind output materials specifies in advance either the binding processing for binding sheets by using a staple or the binding processing for binding sheets without using a staple, and then instructs to perform printing or copying.

If the remaining amount of staples is zero or small when performing print or copy processing with a specification of the binding processing for binding sheets by using a staple, the following problems may arise. One problem is that, even during the binding processing in which sheets are bindable without using a staple, the binding processing is interrupted and suspended until staples are replenished. Another problem is that, if staples run out during print processing or copy processing of a plurality of copies, the binding processing is interrupted and suspended until staples are replenished.

### SUMMARY OF THE INVENTION

The present invention is directed to a mechanism for selectively switching the binding processing according at least to the remaining amount of consumable materials required for the binding processing even if the binding processing for binding sheets by using a staple is specified.

According to an aspect of the present invention, a sheet processing apparatus includes a first binding unit configured to bind sheets by using a consumable material, a second binding unit configured to bind sheets without using the consumable material, and a control unit configured to control the sheet processing apparatus to perform binding processing on sheets by using the first or the second binding unit, wherein the control unit determines whether to perform the binding processing by using the first binding unit or by using the second binding unit according at least to a remaining amount of the consumable material.

Further features of the present invention will become apparent from the following description of exemplary embodiments with reference to the attached drawings.

### BRIEF DESCRIPTION OF THE DRAWINGS

FIG. 1 is a block diagram illustrating a hardware configuration of an image processing apparatus.

FIG. 2 is a sectional view illustrating the image processing apparatus.

FIG. 3 illustrates sheet binding positions.

FIGS. 4A and 4B illustrate binding processing by a binding unit.

FIGS. 5A and 5B illustrate binding processing by a stapleless binding unit.

FIG. 6 illustrates an operation screen displayed on an operation unit.

FIG. 7 is a flowchart illustrating a control method for determining a binding processing method.

FIGS. 8A and 8B illustrate operation screens displayed on the operation unit.

FIG. 9 is a flowchart illustrating a control method for determining a binding processing method.

FIG. 10 illustrates an operation screen displayed on the operation unit.

FIGS. 11A and 11B illustrate operation screens displayed on the operation unit.

FIG. 12 is a flowchart illustrating a control method performed when a user selects a binding processing method.

FIG. 13 is a flowchart illustrating a control method for determining a binding processing method.

FIGS. 14A and 14B illustrate a staple binding unit.

### DESCRIPTION OF THE EMBODIMENTS

Exemplary embodiments according to the present invention will be described in detail below with reference to the accompanying drawings. The following exemplary embodiments are not intended to limit the scope of the present invention according to the appended claims. Not all of the combinations of the features described in the exemplary embodiments are indispensable to the solutions for the present invention.

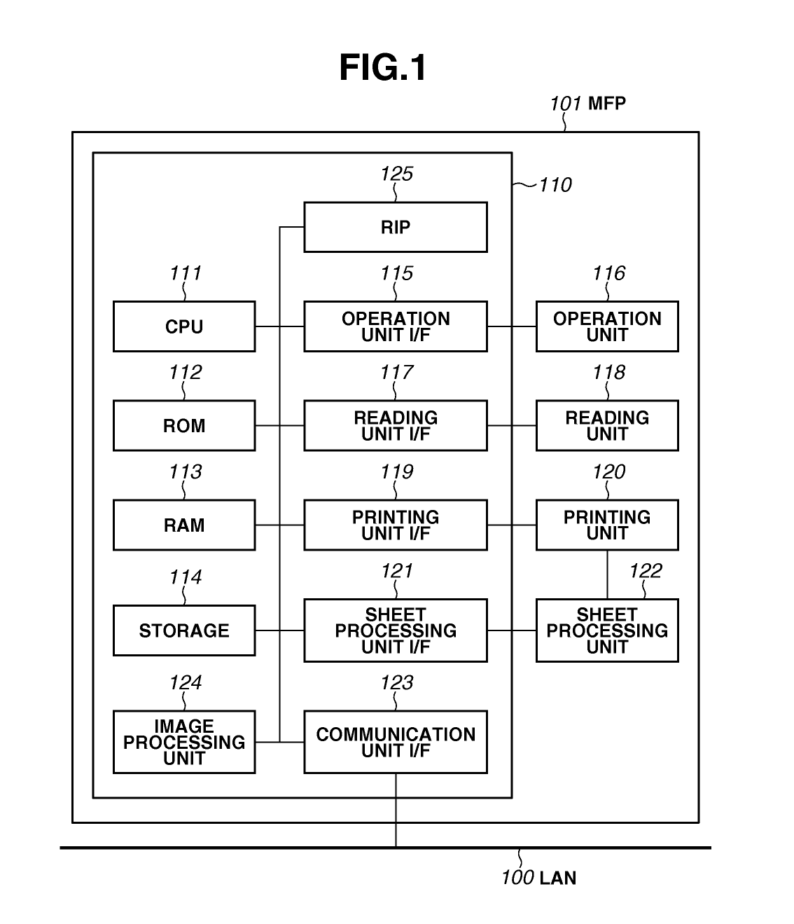

A first exemplary embodiment according to the present invention will be described below. FIG. 1 is a block diagram illustrating a hardware configuration of an image processing apparatus according to the present exemplary embodiment. In the present exemplary embodiment, a Multifunction Peripheral (MFP) 101 is described as an example of an image processing apparatus.

The MFP 101 is provided with a reading function of reading an image on a sheet, and a printing function of printing an image on a sheet. The MFP 101 is further provided with a post-processing function of binding a plurality of sheets with an image printed thereon, aligning a plurality of sheets, and discharging a plurality of sheets onto a plurality of trays. Sheets include paper such as plain paper and thick paper, and overhead projector (OHP) sheets.

Although, in the present exemplary embodiment, the MFP 101 is described as an example of an image processing apparatus, the image processing apparatus may be, for example, a printer not having the reading function.

A control unit 110 including a central processing unit (CPU) 111 controls operations of the entire MFP 101. The CPU 111 reads a control program stored in a read only memory (ROM) 112 or a storage 114, and performs various controls such as reading control and printing control. The ROM 112 stores control programs executable by the CPU 111. A random access memory (RAM) 113 is a main memory for the CPU 111 and is used as a work area and as a temporary storage area for loading a control program stored in the storage 114. The storage 114 stores image data, print data, various programs, various kinds of history information, and various kinds of setting information. Although, in the present exemplary embodiment, an auxiliary storage device such as a hard disk drive (HDD) is assumed as the storage 114, a FLASHDISK represented by a solid state drive (SSD) may be used instead of an HDD.

Although, in the MFP 101 according to the present exemplary embodiment, one CPU 111 uses one memory (RAM 113) to perform each piece of processing illustrated in flowcharts (described below), the configuration is not limited thereto, and other configurations may also be applicable. For example, a plurality of CPUs, RAMs, ROMs, and storages may be operated in a collaborative way to perform each piece of processing of flowcharts (described below). Further, part of processing may be performed by using a hardware circuit such as an Application Specific Integrated Circuit (ASIC) and a Field Programmable Gate Array (FPGA).

An operation unit interface (I/F) 115 connects an operation unit 116 and the control unit 110. The operation unit 116 displays information to a user and inputs an instruction from the user. To this end, the operation unit 116 is provided with a touch panel display for displaying operation screens (described below), and various hardware keys such as a start button and setting keys. The user presses keys displayed on the touch panel display. The operation unit 116 may have a display and various hardware keys instead of the touch panel display. In this case, the user inputs instructions by using the hardware keys. Further, the operation unit 116 may have only a touch panel display.

A reading unit I/F 117 connects a reading unit 118 and the control unit 110. The reading unit 118 reads an image on a sheet and converts the image into image data such as binary data. The image data generated by the reading unit 118 is transmitted to an image processing unit 124 via the reading unit I/F 117. The image processing unit 124 performs image processing such as data compression on the relevant image data. The image data subjected to the image processing is stored in the storage 114 or the RAM 113 of the control unit 110. The image data is transmitted to an external apparatus via a communication unit I/F 123 or printed on a sheet.

A printing unit I/F 119 connects a printing unit 120 and the control unit 110. Image data to be printed (printing target image data) is transmitted from the control unit 110 to the printing unit 120 via the printing unit I/F 119. The printing unit 120 receives a control command and printing target image data from the CPU 111, and prints an image based on the relevant image data on a sheet such as paper.

A sheet processing unit I/F 121 connects a sheet processing unit 122 and the control unit 110. The sheet processing unit 122 receives a control commands from the CPU 111, and, according to the control command, performs post-processing on sheets printed by the printing unit 120. For example, the sheet processing unit 122 performs post-processing such as aligning a plurality of sheets, discharging a plurality of sheets onto a plurality of trays, applying saddle stitch bookbinding, making punch holes, and binding a plurality of sheets. For example, post-processing functions and post-processing capabilities provided by the sheet processing unit 122 are notified to the control unit 110 in advance via the sheet processing unit I/F 121 and further notified to the storage 114 or the RAM 113.

In the present exemplary embodiment, the sheet processing unit 122 is capable of performing the binding processing (binding means) for binding a plurality of sheets at least by using a staple, and the binding processing (binding means) for binding a plurality of sheets without using a staple.

The control unit 110 is further connected to a local area network (LAN) 100 via the communication unit I/F 123. The communication unit I/F 123 transmits image data and information to an external apparatus (a mail server, a file server, a personal computer (PC), etc.) on the LAN 100, and receives image data and information from an external apparatus on the LAN 100. The communication unit I/F 123 further communicates with an external apparatus via a network such as a wireless LAN (not illustrated) and communicates with an external apparatus via a local interface such as a universal serial bus (USB). Print data received by the communication unit I/F 123 is stored in the storage 114.

The print data received via the communication unit I/F 123 is analyzed by a software module (a page description language (PDL) analysis unit (not illustrated)) for analyzing print data stored in the storage 114 or the ROM 112. The PDL analysis unit analyzes the print data represented by various types of Page Description Languages (PDLs) stored in the storage 114. The print data includes a code relating to print attributes and a code relating to drawing. The print data includes information about the number of copies and the binding processing set for the entire print data or for each page, and print attribute information such as a sheet size, a sheet type, and a sheet feed stage at the time of output.

The PDL analysis unit temporarily stores the print attribute settings (print attribute information) acquired by analyzing the print data, in the RAM 113 or the storage 114.

Further, the PDL analysis unit generates an intermediate code based on the print data. The PDL analysis unit analyzes a drawing code included in the print data, and converts it into an intermediate code. The intermediate code has a format more suitable for drawing processing (rasterization) than the print data itself, and is mainly composed of edge coordinates and edge-to-edge filling data.

Based on the result of the PDL analysis, the PDL analysis unit calculates the number of sheets to be output and stores the result in the RAM 113 or the storage 114 as print attribute information. The print attribute information acquired or calculated by the PDL analysis unit is referred to if necessary when print processing and post-processing are performed based on the print data. The intermediate code generated by the PDL analysis unit is converted into image data by a raster image processor (RIP) 125.

The RIP 125 performs rendering processing on the intermediate code generated by the PDL analysis unit to generate image data to be printed by the printing unit 120. The image data generated by the RIP 125 is stored in the storage 114 or the RAM 113 of the control unit 110, is transmitted to an external apparatus via the communication unit I/F 123, and is printed on a sheet by the printing unit 120.

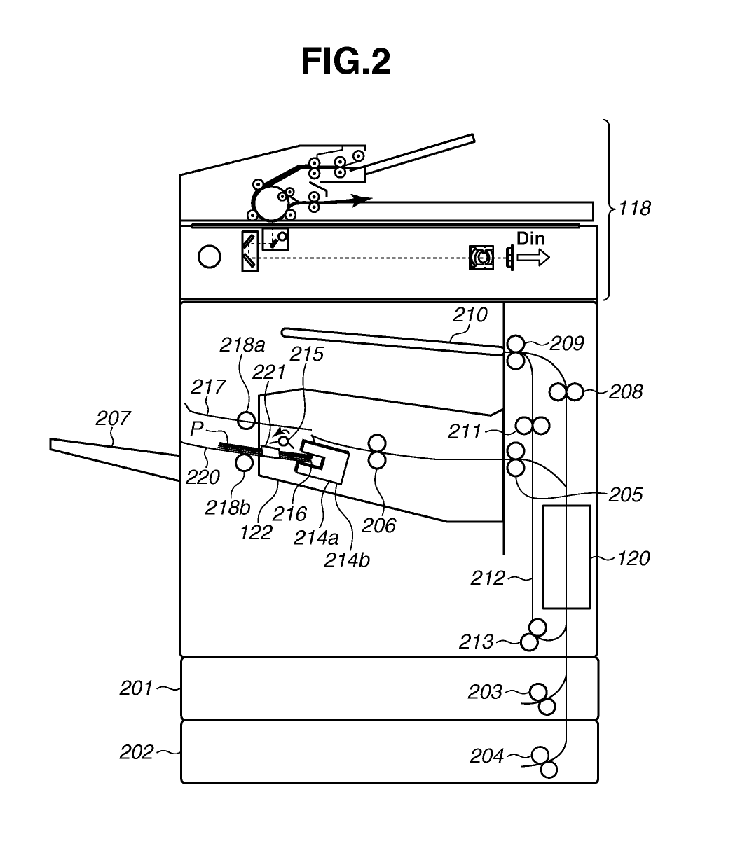

FIG. 2 is a sectional view of the MFP 101. Referring to FIG. 2, the sheet processing unit 122 is disposed inside the housing of the MFP 101. However, the arrangement of the sheet processing unit 122 is not limited to the example illustrated in FIG. 2. The sheet processing unit 122 may be provided as a separate unit adjacently connected to the MFP 101.

Sheet feeding units 201 and 202 store sheets respectively. Referring to FIG. 2, although the MFP 101 is provided with two different sheet feeding units, the number of sheet feeding units is not limited to 2. A feeding roller 203 feeds a sheet stored in the sheet feeding unit 201 to the printing unit 120. A feeding roller 204 feeds a sheet stored in the sheet feeding unit 202 to the printing unit 120. The printing unit 120 prints an image onto a first surface of a fed sheet. The printing unit 120 may employ either the ink-jet method for printing an image on a sheet by discharging ink thereon or the electrophotographic method for printing an image on a sheet by fixing toner thereon.

In one-sided printing, the printed sheet is guided to conveyance rollers 205 and 206. The conveyance rollers 205 and 206 convey the sheet to the sheet processing unit 122. The sheet guided by the conveyance roller 206 is discharged onto an intermediate tray 220.

The intermediate tray 220 is inclined in such a manner that the downstream side in the sheet discharge direction (the upper left side in FIG. 2) is positioned upwardly in the perpendicular direction, and the upstream side in the sheet discharge direction (the lower right side in FIG. 2) is positioned downwardly in the perpendicular direction. In such a configuration, a plurality of sheets can be held therein. The intermediate tray 220 is provided with a bundle discharge roller pair of an upper bundle discharge roller 218a and a lower bundle discharge roller 218b, disposed on the downstream side, and a leading-in paddle 215 disposed above the intermediate portion. The upper bundle discharge roller 218a is supported by a guide 217.

The guide 217 is configured to be vertically movable by a motor (not illustrated). Therefore, according to the open/close operation of the guide 217, the upper bundle discharge roller 218a disposed on the guide 217 can be brought into contact with and separated from the lower bundle discharge roller 218b. Therefore, according to the thickness of a bundle of sheets held by the intermediate tray 220, the distance between the rollers of the bundle discharge roller pair can be adjusted.

The CPU 111 upwardly moves the guide 217 to separate the lower bundle discharge roller 218b from the upper bundle discharge roller 218a. In this state, the CPU 111 causes a sheet P discharged from the conveyance roller 206 to be conveyed into the intermediate tray 220.

An alignment member 221 is disposed on each of the front and rear sides in the width direction perpendicular to the sheet conveyance direction, on the intermediate tray 220. The alignment members 221 move in the width direction by a front alignment motor (not illustrated) and a rear alignment motor (not illustrated), respectively. When the MFP 101 is viewed in the orientation illustrated in FIG. 2, the “front side” refers to the portion on the front side of the paper, and the “rear side” refers to the portion on the rear side of the paper. The leading-in paddle 215 rotates around a rotation shaft in such a direction that the sheets are pressed toward a stopper 216 (e.g., in the counterclockwise direction illustrated in FIG. 2).

After the sheet P is conveyed by the conveyance roller 206 and then discharged onto the intermediate tray 220, the sheet P slides on the sheet stacking face of the intermediate tray 220 or on the sheets stacked on the intermediate tray 220 due to the inclination of the intermediate tray 220 and the sheet pressing action of the leading-in paddle 215.

The sheet P discharged onto the intermediate tray 220 is subjected to the alignment processing by the alignment members 221 during gliding, and then stops when the rear edge of the sheet P (the upstream side end in the sheet discharge direction) hits the stopper 216.

The bundle of sheets aligned on the intermediate tray 220 is subjected to the binding processing by a staple binding unit 214a or a stapleless binding unit 214b as required. The staple binding unit 214a and the stapleless binding unit 214b are configured to be movable perpendicularly to the sheet conveyance direction, along the outer circumference of the intermediate tray 220, and therefore are movable to a binding position specified by the user. The binding units 214a and 214b are capable of binding the rear edge of the bundle of sheets in the conveyance direction, which is held on the intermediate tray 220.

The bundle of sheets subjected to the post-processing such as the binding processing by the sheet processing unit 122 is discharged onto a discharge unit 207. More specifically, the guide 217 is moved to contact the upper bundle discharge roller 218a with the top sheet in the intermediate tray 220. In this contact state, the bundle discharge roller pair is rotatably driven to discharge the bundle of sheets subjected to the post-processing onto the discharge unit 207.

In a case of two-sided printing, a sheet with the first surface printed by the printing unit 120 is guided to a conveyance roller 208, and the conveyance roller 208 conveys the sheet to a conveyance roller 209. The conveyance roller 209 conveys the sheet to the reversal path 210. When the rear edge of the sheet reaches the conveyance roller 209, the conveyance roller 209 starts reverse rotation to convey the sheet to a conveyance roller 211. The conveyance roller 211 conveys the sheet to a conveyance roller 213 via a two-sided printing conveyance path 212. The conveyance roller 213 conveys the sheet to the printing unit 120. The printing unit 120 prints an image on the second surface of the sheet. The sheet subjected to two-sided printing is led to the conveyance rollers 205 and 206. The conveyance rollers 205 and 206 convey the sheet to the sheet processing unit 122 in which post-processing such as binding processing is performed in a similar way to the case of one-sided printing.

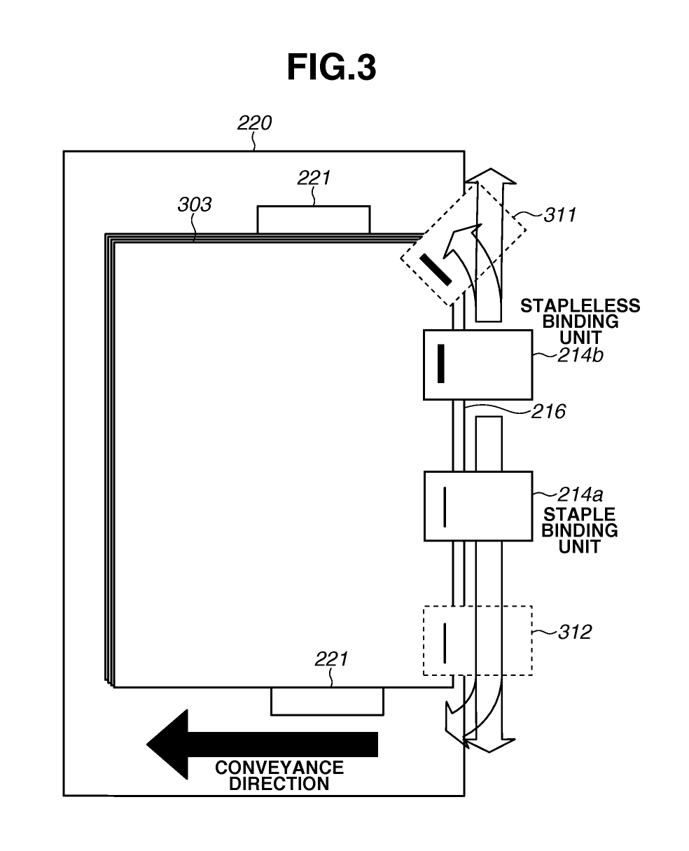

FIG. 3 illustrates a binding position of the binding unit 214a or 214b and a plurality of sheets 303. The sheet processing unit 122 is configured to move the binding unit 214a or 214b to the binding position according to the information about the binding processing received from the CPU 111, and bind the plurality of the sheets 303. For example, the CPU 111 can move the binding unit 214a or 214b to a position 311 or 312, for example, and bind the plurality of sheets 303 at the position 311 or 312.

The staple binding unit 214a and the stapleless binding unit 214b may be provided in the sheet processing unit 122 as one unit. Although movable areas of the binding units 214a and 214b are illustrated in FIG. 3, movable areas wider than them may be provided. When the stapleless binding unit 214b and the staple binding unit 214b are provided as different units, an evacuation area (not illustrated) for avoiding a physical interference between them may be provided.

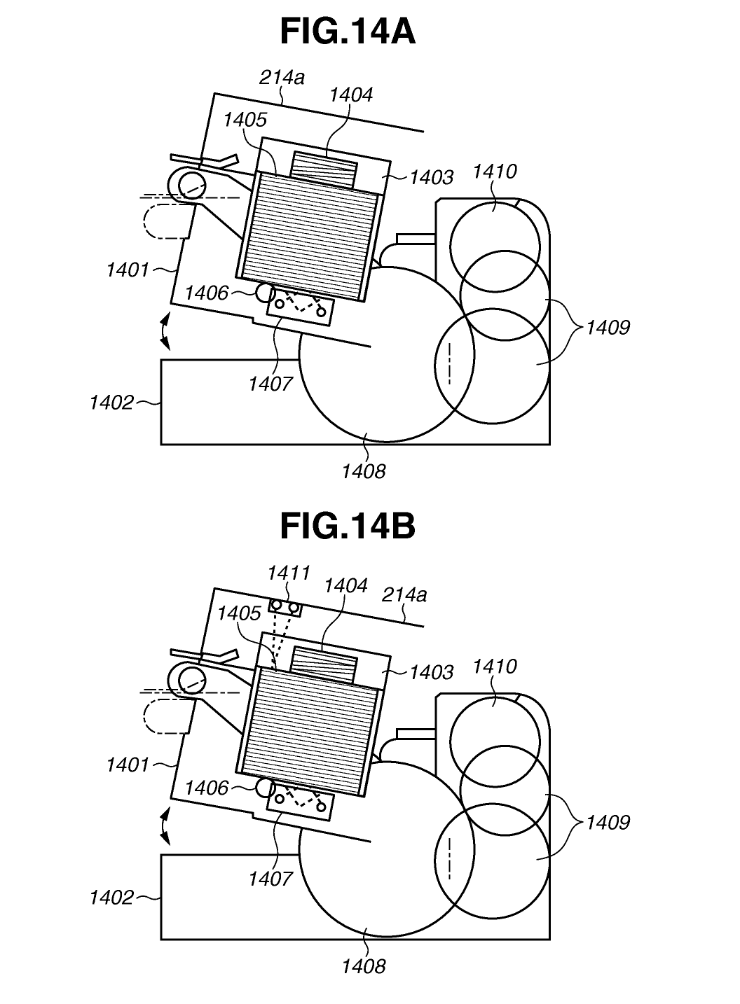

FIG. 14A illustrates the binding processing by the staple binding unit 214a. A staple cartridge 1403 attached to a forming plate 1401 is loaded with staples 1405 as consumable materials to be used for binding sheets. The staples 1405 are downwardly pressed by a spring 104. The user replenishes the staples 1405 by replacing the staple cartridge 1403. Upon detection of replacement of the staple cartridge 1403, the CPU 111 initializes a staple binding process count Q to 0.

The staple binding unit 214a performs the binding processing by putting the staples 1405 into a plurality of sheets discharged on the intermediate tray 220 (hereinafter referred to as a staple binding process). First of all, the forming plate 1401 separates one staple 1405 conveyed from the rear side by a roller 1406, and then forms it into a U-shape. Then, the CPU 111 turns ON a motor 1410 to rotate an eccentric cam gear 1408 via a gear train 1409. The forming plate 1401 is moved to swing toward a table 1402 by the rotation of the eccentric cam gear 1408. When the forming plate 1401 is moved to swing, a U-shaped staple is put into a plurality of sheets positioned between the forming plate 1401 and the table 1402 and then pressed onto the table 1402, thus performing staple binding. When the staple binding is performed, the CPU 111 updates the staple binding process count Q.

The CPU 111 can detect the remaining amount of the staples 1405. The CPU 111 determines the remaining amount of staples R based on the initial number of staples N loaded in the staple cartridge 1403 and the staple binding process count Q (R=N−Q). The determined remaining amount of the staples is stored in the RAM 113 or the storage 114, and is used in flowcharts (described below) and in notifying the user of the remaining amount of consumable materials.

Although, in the present exemplary embodiment, the remaining amount of staples R is calculated based on the staple binding process count Q, the remaining amount of staples R may be detected by measuring the height of the staples 1405 stored in a stacked state in the staple binding unit 214a as illustrated in FIG. 14B. The distance measuring sensor 1411 detects the top surface of the staples 1405, and is disposed at a position where the top surface of the staple cartridge 1403 of the staple binding unit 214a can be measured. The distance measuring sensor 1411 includes a light emitting unit for irradiating the staples 1405 stored in the staple cartridge 1403 with light such as infrared light, and a light receiving unit for receiving light reflected by the staples 1405. The distance measuring sensor 1411 evaluates and calculates the light received by the light receiving unit and converts it into a distance. The CPU 111 acquires as appropriate the distance to the staples 1405 detected by the distance measuring sensor 1411 via the sheet processing unit 122 and the sheet processing unit I/F 121, and determines the remaining amount of staples R based on the detected distance. The remaining amount of staples R determined based on distance measurement is stored in the RAM 113 or the storage 114, and is used in flowcharts (described below) and in notifying the user of the remaining amount of consumable materials.

Referring back to FIG. 14A, an optical sensor 1407 is a reflective optical sensor for detecting the presence or absence of the staples 1405. In the present exemplary embodiment, the presence or absence of the staples 1405 is detected by the optical sensor 1407 disposed at the bottom of the staple cartridge 1403.

The CPU 111 acquires, as appropriate, a result of detecting the presence or absence of the staples 1405 detected by the staple binding unit 214a via the sheet processing unit 122 and the sheet processing unit I/F 121, and stores the result in the RAM 113 or the storage 114. Information about the presence or absence of the staples 1405 is used in flowcharts (described below) and in notifying the user of the replenishment of consumable materials.

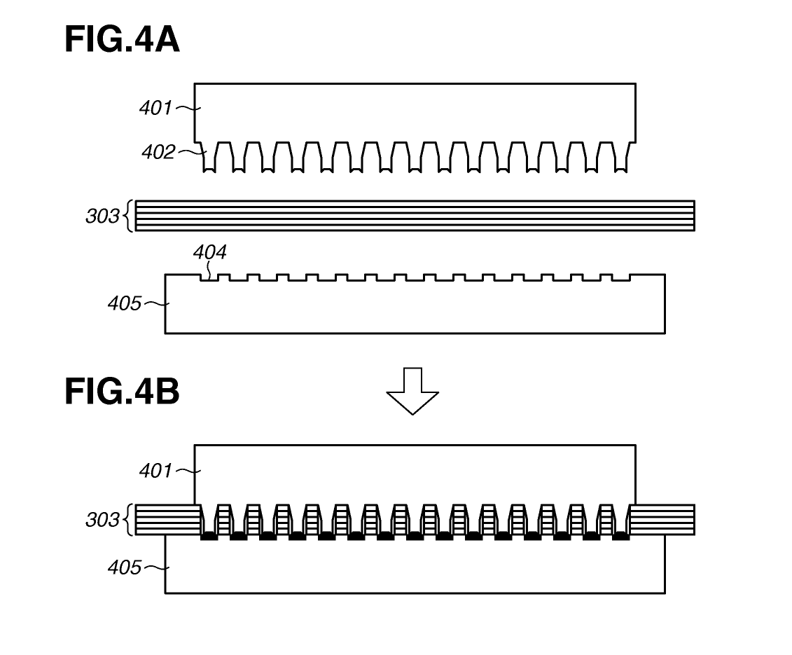

FIGS. 4A and 4B illustrate the binding processing (hereinafter, referred to as a stapleless binding process) performed by the stapleless binding unit 214b to bind a plurality of sheets without using a staple. In the present exemplary embodiment, to bind a plurality of sheets, the stapleless binding unit 214b pressurizes the sheets from the top downward and from the bottom upward to contact them firmly to each other. FIG. 4A illustrates a state where the stapleless binding unit 214b has moved to a binding position for binding a plurality of sheets. An upper mold 401 pressurizes a plurality of sheets from the top downward. A plurality of convex blades 402 is arranged on the upper mold 401, and each blade 402 pressurizes the sheets. A lower mold 405 pressurizes a plurality of sheets from the bottom upward. A plurality of concave portions 404 corresponding to a plurality of the blades 402 is arranged on the lower mold 405, and each concave portion 404 catches each corresponding blade 402.

FIG. 4B illustrates a state where the upper mold 401 and the lower mold 405 pressurize a plurality of sheets from the top downward and from the bottom upward, respectively. The upper mold 401 and the lower mold 405 pressurize a plurality of sheets to enable binding the sheets. Further, a plurality of the blades 402 and a plurality of the concave portions 404 pressurize a plurality of portions of the sheets to make the sheets difficult to separate.

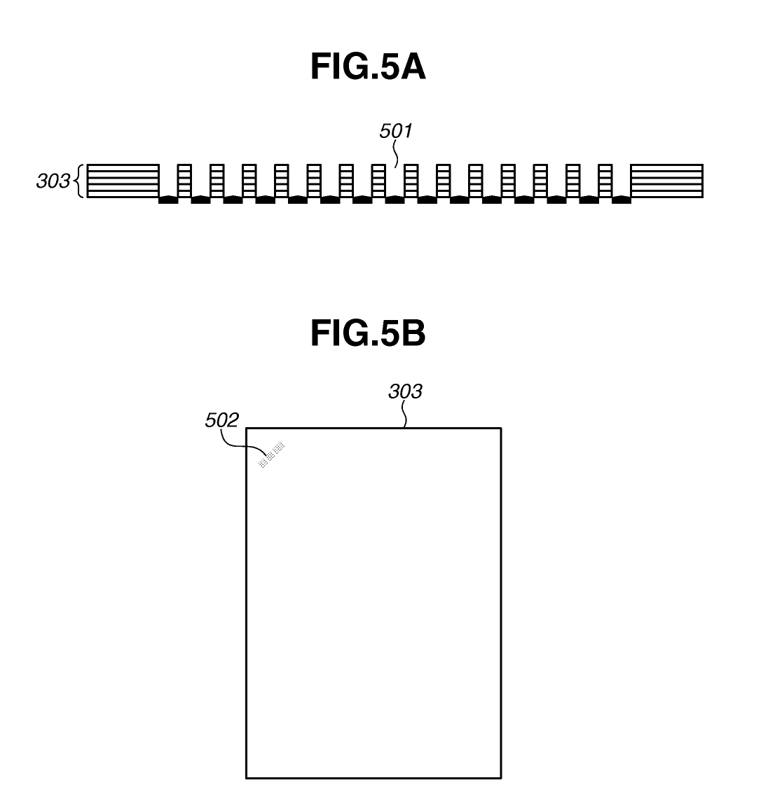

FIGS. 5A and 5B illustrate sheets after having been subjected to the stapleless binding process. Referring to FIG. 5A, as illustrated in an area 501, the upper mold 401 and the lower mold 405 pressurize a binding position to crush the areas 501 of the sheets to firmly contact the sheets to each other, thus binding the sheets. FIG. 5B illustrates a plurality of the sheets 303 subjected to the stapleless binding process at a binding position 502, when viewed from the top. Referring to FIG. 5B, a sheet deformation by the binding processing is illustrated in gray. Traces of deformations due to pressurization by the upper mold 401 and the lower mold 405 can be actually viewed. Stapleless binding process enables binding sheets in this way without using consumable materials such as staples. On the other hand, the stapleless binding process has a mechanism of firmly compressing a plurality of sheets to achieve binding, and therefore can bind the number of sheets (e.g., up to 10 sheets) fewer than that of the staple binding process.

Next, the binding processing control will be described below. The MFP 101 according to the present exemplary embodiment is capable of performing the binding processing with either the staple binding process or the stapleless binding process. The user using the MFP 101 can specify the binding processing (the staple binding process or the stapleless binding process) for print processing and copy processing. When the user specifies the staple binding process, the CPU 111 performs the binding processing by using the staple binding unit 214a. When the user specifies the stapleless binding process, the CPU 111 performs the binding processing by using the stapleless binding unit 214b. On the other hand, when the user does not specify the binding processing, the CPU 111 discharges a bundle of sheets without performing the binding processing.

In the staple binding process, the binding processing cannot be performed in a state where the staples 1405 run out (a state where no staples 1405 are loaded). In view of such a situation, in the present exemplary embodiment, the binding processing can be switched to the stapleless binding process even if the staple binding process is specified, according to the remaining amount of the staples 1405.

The user can change settings for functions provided by the MFP 101 by pressing a Set/Register button (not illustrated) of the operation unit 116. The user can make setting for staple alternative processing as one setting item for the printing operation control.

When the user selects the setting for the staple alternative processing in a Setting/Registration screen (not illustrated), the CPU 111 controls the operation unit 116 to display an operation screen for setting the staple alternative processing.

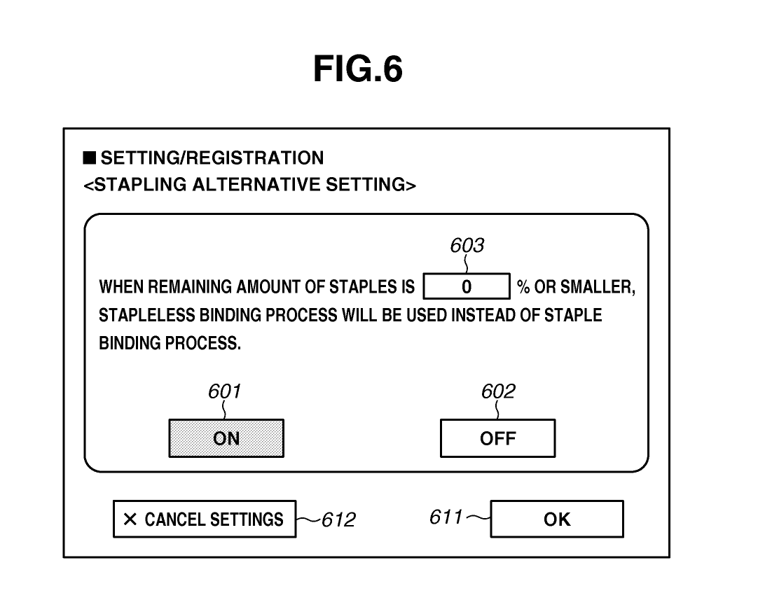

FIG. 6 illustrates an example of a setting screen for the staple alternative processing displayed on the operation unit 116, i.e., an example case where the staple alternative processing is enabled. The user can change the setting for the staple alternative processing via the setting screen illustrated in FIG. 6. In the present exemplary embodiment, the setting in the screen illustrated in FIG. 6 is stored in the storage 114 or the RAM 113 as a common setting for a case where the staple binding process is used by the MFP 101.

When the user presses an “ON” key 601, the CPU 111 allows (turns ON) the setting for using the stapleless binding process instead of the staple binding process according to the remaining amount of the staples 1405. When the user presses an “OFF” key 602, the CPU 111 disables (turns OFF) the setting for using the stapleless binding process instead of the staple binding process according to the remaining amount of the staples 1405. The “ON” key 601 and the “OFF” key 602 operate as a toggle switch, i.e., only one key is selected and the selected key is clearly displayed to the user, as illustrated in FIG. 6.

An area 603 is used to input a threshold value for the staple alternative processing. The user inputs a threshold value for the staple alternative processing by percentage by using a numeric keypad (not illustrated) on the operation unit 116. The CPU 111 performs control so that, when the remaining amount of the staples 1405 detected via the staple binding unit 214a is equal to or smaller than the threshold value specified in the area 603, the stapleless binding process is performed instead of the staple binding process.

An “OK” key 611 is used to store, in the storage 114 or the RAM 113, information about the staple alternative processing set by the user, and close the relevant setting screen. A “Cancel Settings” key 612 is used to cancel the setting for the staple alternative processing set by the user, and close the relevant setting screen.

Although, in the present exemplary embodiment, the user inputs a threshold value as an example case, the configuration is not limited thereto. For example, a threshold value to be used when the staple alternative processing is performed may be fixedly set in the MFP 101. Further, the staple alternative processing may be performed when the CPU 111 determines that the staples run out (the remaining amount of staples becomes 0).

Further, the user may make settings for the staple alternative processing by remote-controlling the MFP 101 or by transmitting setting information to the MFP 101 via a web browser of a print control apparatus (not illustrated) such as PC and a print server.

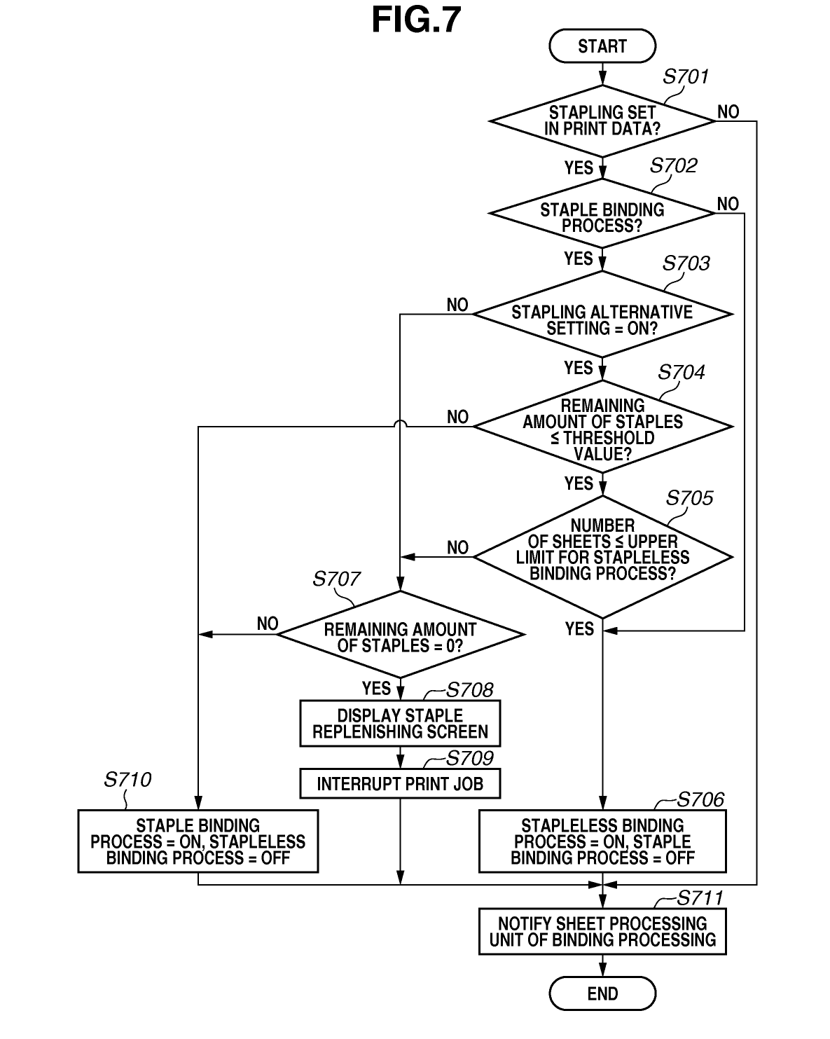

FIG. 7 is a flowchart illustrating a control for determining the binding processing to be applied to sheets during execution of the print processing. The sheet processing unit 122 performs the binding processing on the sheets printed by the printing unit 120, according to the binding processing determined by the flowchart illustrated in FIG. 7.

Each operation (step) illustrated in the flowchart in FIG. 7 is implemented when the CPU 111 loads a control program stored in the ROM 112 or the storage 114 into the RAM 113 and then executes the loaded control program.

The CPU 111 receives print data from a PC, a print server, etc. via the communication unit I/F 123 and, after completing the print data analysis by the PDL analysis unit, performs the processing in the flowchart illustrated in FIG. 7.

In step S701, the CPU 111 determines whether the binding processing is set for the print data, with reference to the print attribute information analyzed by the PDL analysis unit (not illustrated) and stored in the RAM 113 or the storage 114. When the CPU 111 determines that the staple binding process or the stapleless binding process is specified for the print data (YES in step S701), the processing proceeds to step S702. On the other hand, when the CPU 111 determines that neither the staple binding process nor the stapleless binding process is specified for the print data (NO in step S701), the processing proceeds to step S711.

In step S702, the CPU 111 determines whether the staple binding process is selected as the stapling processing, with reference to the print attribute information. When the CPU 111 determines that the staple binding process is selected (YES in step S702), the processing proceeds to step S703. On the other hand, when the CPU 111 determines that the staple binding process is not selected (the stapleless binding process is selected) (NO in step S702), the processing proceeds to step S706.

In step S703, the CPU 111 determines whether the setting for using the stapleless binding process instead of the staple binding process according to the remaining amount of staples is enabled, with reference to the information about the staple alternative processing stored in the storage 114 or the RAM 113. When the CPU 111 determines that the setting for using the stapleless binding process instead of the staple binding process is enabled (YES in step S703), the processing proceeds to step S704. On the other hand, when the CPU 111 determines that the setting for using the stapleless binding process instead of the staple binding process is not enabled (disabled) (NO in step S703), the processing proceeds to step S707.

In step S704, the CPU 111 refers to the remaining amount of staples R stored in the RAM 113 or the storage 114, and determines whether the remaining amount of staples R is equal to or smaller than a predetermined threshold value set for the staple alternative processing. When the CPU 111 determines that the remaining amount of staples R is equal to or smaller than the threshold value (YES in step S704), the processing proceeds to step S705. On the other hand, when the CPU 111 determines that the remaining amount of staples R is larger than the threshold value (NO in step S704), the processing proceeds to step S710.

In step S705, the CPU 111 determines whether the number of sheets to be printed calculated by the PDL analysis unit is equal to or fewer than the upper-limit number of sheets that can be subjected to the stapleless binding process. As described above, the stapleless binding process according to the present exemplary embodiment can bind smaller number of sheets than the staple binding process. Therefore, the CPU 111 needs to determine whether the number of sheets to be printed (i.e., the number of sheets subjected to the binding processing) is equal to or fewer than the upper-limit number of sheets bindable by the stapleless binding process.

The CPU 111 refers to the information about the post-processing of the sheet processing unit 122 received from the sheet processing unit 122 and stored in the storage 114 or the RAM 113 to acquire the upper-limit number of sheets bindable by the stapleless binding unit 214b. When the CPU 111 determines that the number of sheets to be printed is equal to or fewer than the upper-limit number of sheets bindable by the stapleless binding unit 214b (YES in step S705), the processing proceeds to step S706. On the other hand, when the CPU 111 determines that the number of sheets to be printed is larger than the upper-limit number of sheets bindable by the stapleless binding unit 214b (NO in step S705), the processing proceeds to step S707.

In step S706, the CPU 111 enables the stapleless binding process (ON) and disables the staple binding process (OFF), then the processing proceeds to step S711.

On the other hand, in step S707, the CPU 111 determines whether the remaining amount of the staples 1405 loaded in the staple binding unit 214a is zero. The CPU 111 refers to the information about the presence or absence of the staples 1405 acquired by the optical sensor 1407 and stored in the RAM 113 or the storage 114. When the CPU 111 determines that the remaining amount of the staples 1405 is zero (YES in step S707), the processing proceeds to step S708. On the other hand, when the CPU 111 determines that the remaining amount of the staples 1405 is not zero (NO in step S707), the processing proceeds to step S710.

In step S708, the CPU 111 displays information for notifying the user of the necessity of replenishing staples (not illustrated) on the operation unit 116. When the CPU 111 detects that a new staple cartridge is attached in the staple binding unit 214b, this notification is canceled. When a new staple cartridge is attached, the CPU 111 initializes the staple binding process count Q to 0. In step S709, the CPU 111 interrupts the print processing for the relevant print data. Then, the processing proceeds to step S711. On the other hand, in step S710, the CPU 111 enables the staple binding process (ON) and disables the stapleless binding process (OFF). Then, the processing proceeds to step S711.

In step S711, the CPU 111 notifies the sheet processing unit 122 of the binding processing determined in steps S701 to S710 via the sheet processing I/F 121, and terminates the processing of the flowchart.

Although, in the present exemplary embodiment, the processing performed in a case where the number of sheets to be printed calculated based on the print data is larger than the upper-limit number of sheets bindable by stapling set for the print data is not described, for example, the following processing may be performed. When the CPU 111 determines that the binding processing when the number of sheets to be printed exceeds the upper-limit number of sheets is specified, the CPU 111 may control the sheet processing unit 122 not to perform the binding processing. As a specific control method, a technique discussed in Japanese Patent Application Laid-Open No. 2013-252937 is applicable.

Although, in the present exemplary embodiment, an example has been described in which the CPU 111 determines the binding processing according to the remaining amount of staples when the print data received from an external apparatus is printed, the configuration is not limited thereto. For example, the present exemplary embodiment is also applicable to the printing of print data and image data stored in a document storage box in the MFP 101, and to copy processing for printing an image read by the reading unit 118.

As described above, the present exemplary embodiment enables switching the print processing with a specification of the staple binding process to the stapleless binding process if the remaining amount of staples is small. In addition, the user is able to preset whether the staple alternative processing is to be performed and set a threshold value when the staple alternative processing is to be performed, and therefore flexible binding processing according to user's demands can be achieved.

Although, in the present exemplary embodiment, an example has been described in which the CPU 111 determines, after completion of the print data analysis by the PDL analysis unit, whether the staple alternative processing is to be performed and then performs printing, the configuration is not limited thereto. The print data analysis operation and the image data printing operation may be independently performed.

For example, a first program analyzes print data to acquire print attribute information and generate image data. The first program further executes the flowchart illustrated in FIG. 7, and notifies the sheet processing unit 122 of the information about the stapling processing. A second program monitors an area for storing image data and, when it detects that image data for one page has been stored, executes printing of the relevant image. In this case, since the printing of image data and the generation of image data for the following and subsequent pages can be performed in parallel, the time taken for printing can be shortened.

According to the first exemplary embodiment, an example has been described in which the CPU 111 switches the binding processing according at least to the remaining amount of staples when a plurality of the sheets is bound by using a staple. According to a second exemplary embodiment, an example will be described in which the CPU 111 makes an inquiry to the user about whether to switch the binding processing when the print data is printed, in addition to the first exemplary embodiment. The second exemplary embodiment has a similar hardware configuration of a prerequisite apparatus to that according to the first exemplary embodiment. Detailed descriptions of similar configurations to the first exemplary embodiment will be omitted.

In the present exemplary embodiment, as an example, reservation printing is described. In the reservation printing, print data transmitted from a PC is reserved in the storage 114 of the MFP 101 or a print server. In the reservation printing, the MFP 101 does not perform printing immediately after receiving print data. The reserved print data can be printed when the user inputs a password or performs user authentication via an operation unit 116 of an image forming apparatus.

When the user select “Print” on a main screen (not illustrated) displayed on the operation unit 116, the CPU 111 controls the operation unit 116 to display a screen for printing the print data received from a PC or a print server.

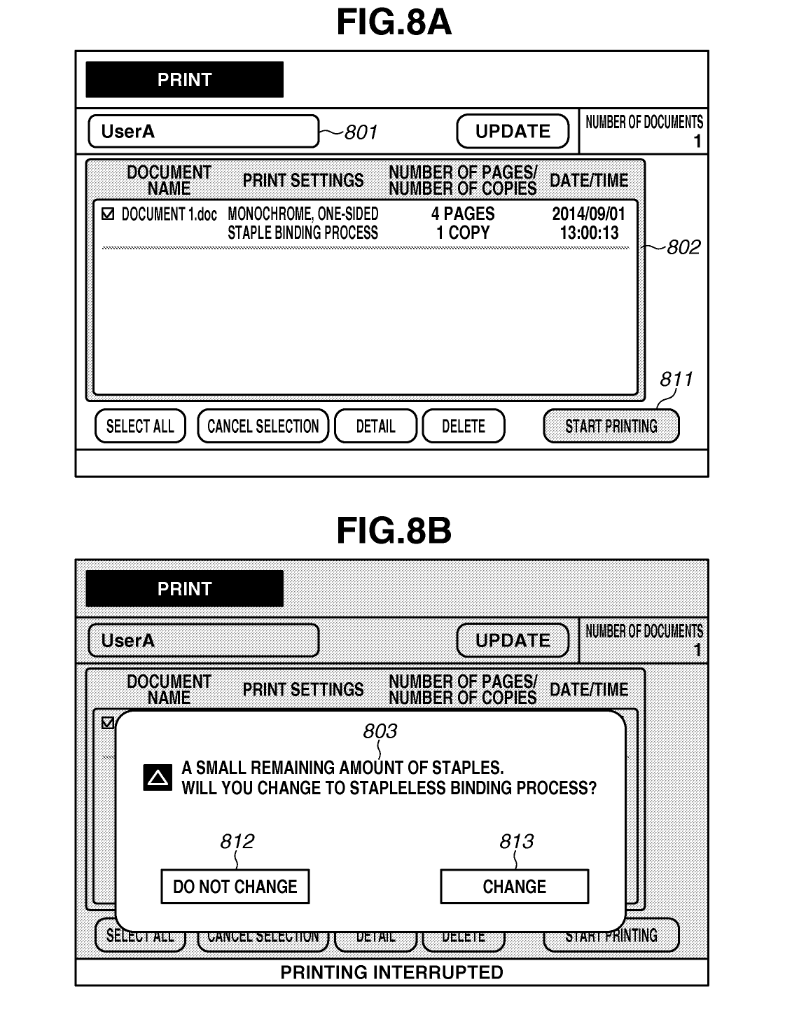

FIG. 8A illustrates an example of a screen for printing the print data displayed on the operation unit 116. Via the selection screen illustrated in FIG. 8A, the user can select data to be printed and instruct to print the relevant print data.

Information 801 is information about a user who logged into the MFP 101 through user authentication. An area 802 is an area for displaying information about print data of the relevant user stored in the MFP 101 or a print server, in list form. This print data list displays print job information including the file name, the print settings, the number of pages, and the date of starting printing. The number of pages cannot be displayed depending on the type of the print data. The user operates the operation unit 116, and presses the area where a desired print job is displayed in the print job list displayed in the area 802, thus selecting target print data.

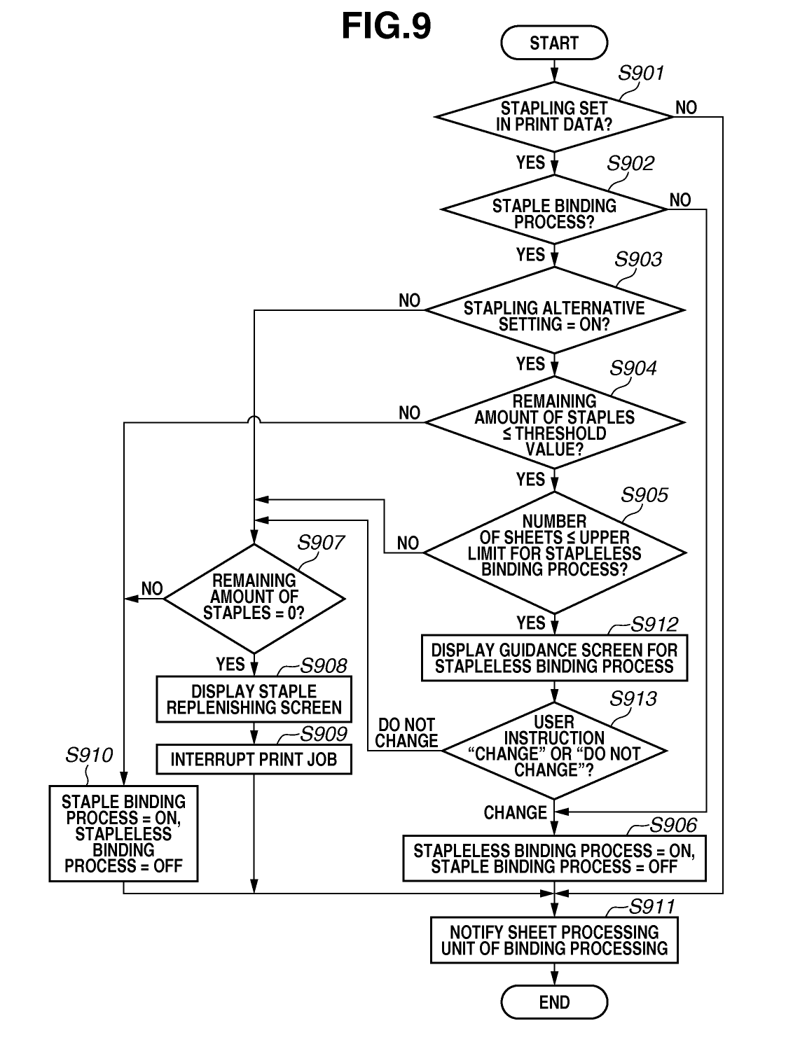

A “Start Printing” key 811 is used to start printing of the selected print data. When the user presses a “Do Not Change” key 812 after selecting a print job, the CPU 111 analyzes the selected print data with the PDL analysis unit (not illustrated). After completing the print data analysis with the PDL analysis unit, the CPU 111 performs the flowchart illustrated in FIG. 9.

FIG. 9 is a flowchart illustrating a control for determining the binding processing to be applied to sheets during execution of the print processing. The sheet processing unit 122 performs the binding processing on the printed sheets by the printing unit 120 according to the binding processing determined by the flowchart illustrated in FIG. 9. Each operation (step) illustrated in the flowchart in FIG. 9 is implemented when the CPU 111 loads a control program stored in the ROM 112 or the storage 114 into the RAM 113 and then executes it.

In steps S901 to S905, the CPU 111 determines whether the stapleless binding process is to be used instead of the staple binding process, similar to step S701 to S705 according to the first exemplary embodiment. When the CPU 111 determines that the number of sheets to be printed is equal to or fewer than the upper-limit number of sheets bindable by the stapleless binding unit 214b (YES in step S905), the processing proceeds to step S912.

In step S912, the CPU 111 controls the operation unit 116 to display an inquiry screen for prompting the user to switch the binding processing to the stapleless binding process. FIG. 8B illustrates an example of an inquiry screen.

Information 803 is information for notifying the user of an option for switching the binding processing to the stapleless binding process. When the CPU 111 detects that the remaining amount of staples is zero, the CPU 111 may notify the user that there is no staple and that printing is not possible until the staple cartridge is replaced, instead of the information 803.

A “Change” key 813 is used when the user intends to switch the binding processing to the stapleless binding process. The “Do Not Change” key 812 is used when the user does not intend to switch the binding processing to the stapleless binding process (when the user intends to continue the staple binding process).

Referring back to the flowchart illustrated in FIG. 9, in step S913, the CPU 111 determines which of the keys 812 and 813 is pressed. When the CPU 111 determines that the “Change” key 813 is pressed (CHANGE in step S913), the processing proceeds to step S906. On the other hand, when the CPU 111 determines that the “Do Not Change” key 812 is pressed (DO NOT CHANGE in step S913), the processing proceeds to step S907.

In steps S906 to S911, the CPU 111 performs similar processing to steps S706 to S711 according to the first exemplary embodiment. In step S906, the CPU 111 determines to use the stapleless binding process as the post-processing. In step S907, the CPU 111 determines whether the remaining amount of the staples 1405 is zero. When the remaining amount of the staples 1405 is not zero (NO in steps S907), then in step S910, the CPU 111 determines to use the staple binding process. On the other hand, when the remaining amount of the staples 1405 is zero (YES in step S907), then in steps S908 and S909, the CPU 111 performs control to interrupt and suspend the relevant print job.

In step S911, the CPU 111 notifies the sheet processing unit 122 of the determined binding processing and job suspension information via the sheet processing I/F 121. Then, the processing of the flowchart is terminated.

Although, in the present exemplary embodiment, the CPU 111 displays a screen for prompting the user to switch the binding processing to the stapleless binding process when printing for the reservation printing is started, but the configuration is not limited thereto. The present exemplary embodiment is also applicable to an image processing apparatus that performs printing immediately after receiving print data. In this case, the CPU 111 needs to perform the flowchart illustrated in FIG. 9 upon completion of the print data analysis.

In the present exemplary embodiment, the flowchart illustrated in FIG. 7 in the first exemplary embodiment can also be performed. For example, in a case of a setting for performing printing immediately after reception of print data, the CPU 111 may perform the staple alternative processing based on the flowchart illustrated in FIG. 7. In a case of a setting for performing reservation printing, the CPU 111 may perform the staple alternative processing based on the flowchart illustrated in FIG. 9. Further, the user may set which one of the staple alternative processing is to be performed as one setting item for printing operation control.

As described above, in the present exemplary embodiment, it is possible to make an inquiry to the user about whether the print processing with the specification of the staple binding process is to be switched to the stapleless binding process or is left unchanged (the staple binding process maintained). Therefore, the binding processing can be switched on a job basis according to the user's demands.

In the second exemplary embodiment, an example has been described in which the CPU 111 makes an inquiry to the user about whether to switch the binding processing when the print data is printed. According to a third exemplary embodiment, an example will be described in which the CPU 111 makes an inquiry to the user about whether to switch the binding processing when the user specifies the binding processing. The third exemplary embodiment has a similar hardware configuration of a prerequisite apparatus to that according to the first exemplary embodiment. Detailed descriptions of similar configurations to the first exemplary embodiment will be omitted.

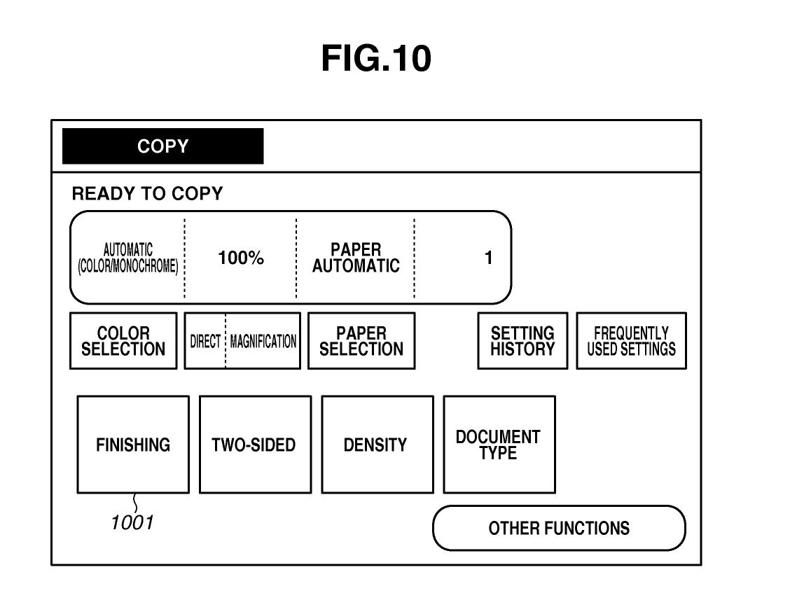

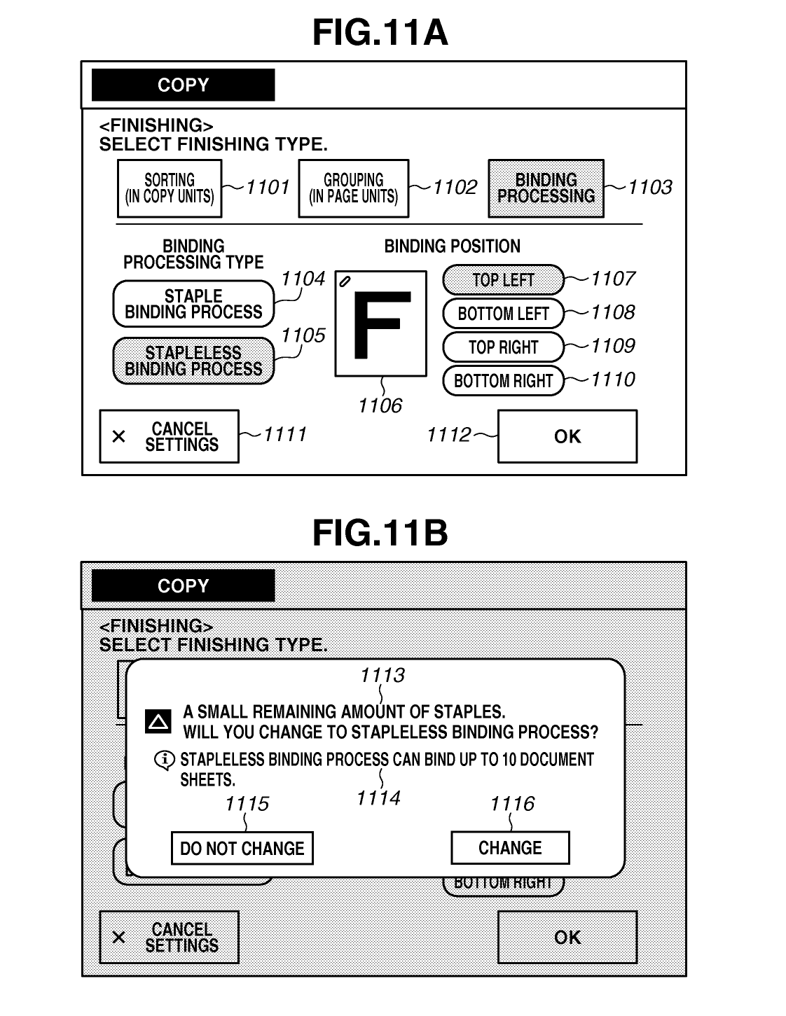

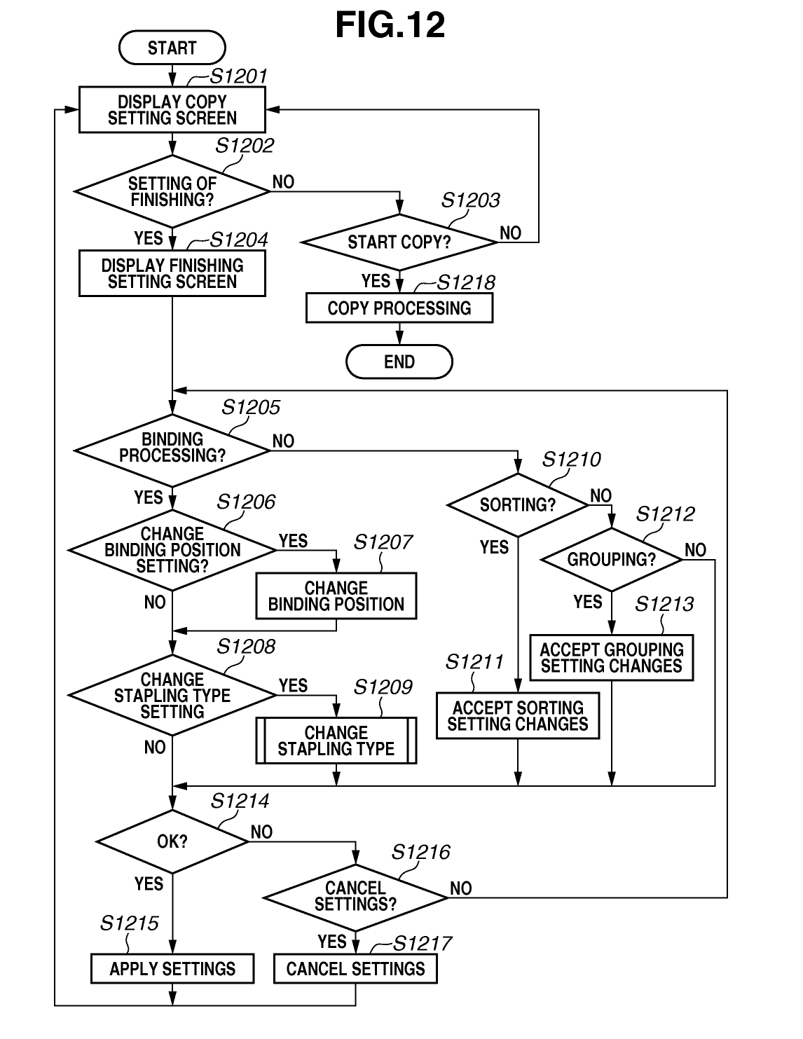

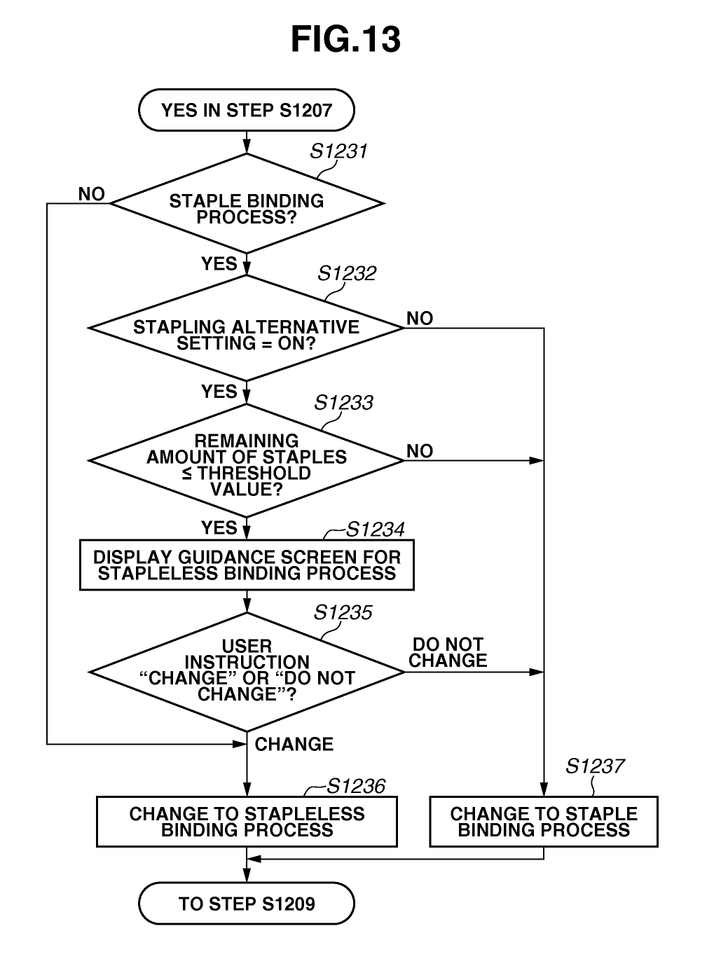

In the present exemplary embodiment, copy processing is described as an example. In the copy processing, the reading unit 118 reads a document and the printing unit 120 prints the read document. FIGS. 10, 11A, and 11B illustrate examples of operation screens displayed on the operation unit 116. FIGS. 12 and 13 are flowcharts illustrating control methods for controlling finishing settings for a copy job. Each operation (step) illustrated in the flowcharts in FIGS. 12 and 13 is implemented when the CPU 111 loads a control program stored in the ROM 112 or the storage 114 into the RAM 113 and then executes it.

When the user selects Copy on a main screen (not illustrated) displayed on the operation unit 116, the CPU 111 executes the relevant control program. In step S1201, the CPU 111 controls the operation unit 116 to display an operation screen for making copy setting. FIG. 10 illustrates an example of a copy screen. The user is able to select color copy or monochrome copy, set the magnification for copy, select the type of two-sided copy, and set the number of copies via the screen illustrated in FIG. 10. If the user wants to set finishing for the copy job, the user presses a “Finishing” key 1001.

In step S1202, the CPU 111 determines whether the “Finishing” key 1001 is pressed on the screen illustrated in FIG. 10. When the “Finishing” key 1001 is pressed (YES in step S1202), the processing proceeds to step S1204. On the other hand, when the “Finishing” key 1001 is not pressed (NO in step S1202), the processing proceeds to step S1203.

In step S1203, the CPU 111 determines whether a start key (not illustrated) is pressed. The start key is provided on the operation unit 116. When the start key is pressed (YES in step S1203), then in step S1218, the CPU 111 starts execution of the copy job. On the other hand, when the start key is not pressed (NO in step S1203), then in step S1201, the CPU 111 receives a further setting via the operation unit 116.

In step S1204, the CPU 111 controls the operation unit 116 to display the operation screen illustrated in FIG. 11A. FIG. 11A illustrates an example of an operation screen displayed on the operation unit 116. A “Sorting” key 1101 is used to sort sheets in copy units. For example, when 10 copies of a 5-page document are printed, 5 sheets corresponding to one copy are discharged as one bundle. A “Grouping” key 1102 is used to align sheets in page units. For example, when 10 copies of a 5-page document are printed, 10 sheets corresponding to an identical page are discharged as one bundle.

FIG. 11A illustrates a state where a “Binding Processing” key 1103 is selected as an example. When the user presses the key 1103, information used to make settings for the binding processing is displayed on the operation unit 116.

A “Staple binding process” key 1104 is used to select the staple binding process, and a “Stapleless binding process” key 1105 is used to select the stapleless binding process. Information 1106 is used to notify the user of a set binding position. Keys 1107 to 1110 are used to select a binding position.

Referring back to the flowchart illustrated in FIG. 12, in step S1205, the CPU 111 determines whether the “Binding Processing” key 1103 is pressed. When the CPU 111 determines that “Binding Processing” key 1103 is pressed (YES in step S1205), the processing proceeds to step S1206. On the other hand, when the CPU 111 determines that the “Binding Processing” key 1103 is not pressed (NO in step S1205), the processing proceeds to step S1210.

In step S1210, the CPU 111 determines whether the “Sorting” key 1101 is pressed. When the CPU 111 determines that the “Sorting” key 1101 is pressed (YES in step S1210), the processing proceeds to step S1211. On the other hand, when the CPU 111 determines that the “Sorting” key 1101 is not pressed (NO in step S1210), the processing proceeds to step S1212. In step S1211, the CPU 111 displays setting items relating to sorting on the operation unit 116, and receives sorting setting changes via the operation unit 116. In step S1212, the CPU 111 determines whether the “Grouping” key 1102 is pressed. When the CPU 111 determines that the “Grouping” key 1102 is pressed (YES in step S1212), the processing proceeds to step S1213. On the other hand, when the CPU 111 determines that the “Grouping” key 1102 is not pressed (NO in step S1212), the processing proceeds to step S1214.

In step S1206, the CPU 111 determines whether any one of the keys 1107 to 1110 for changing the binding position is pressed. When the CPU 111 determines that either one of the keys 1107 to 1110 is pressed (YES in step S1206), the processing proceeds to step S1207. On the other hand, when the CPU 111 determines that none of the keys 1107 to 1110 is pressed (NO in step S1206), the processing proceeds to step S1208. In step S1207, the CPU 111 changes the setting of the binding position at which a plurality of sheets is to be bound according to the key pressed in step S1206. Then, the CPU 111 updates the display of the binding position indicated in the information 1106 according to the key pressed in step S1206.

In step S1208, the CPU 111 determines whether any one of the keys 1104 and 1105 for switching the stapling type is pressed. When the CPU 111 determines that any one of the keys 1104 and 1105 is pressed (YES in step S1208), the processing proceeds to step S1209. On the other hand, when the CPU 111 determines that neither of the key 1104 nor 1105 is pressed (NO in step S1208), the processing proceeds to step S1214. In step S1209, the CPU 111 changes the setting of the stapling type to be used for the binding processing according to the key pressed in step S1208. Details of step S1209 will be described below with reference to the flowchart illustrated in FIG. 13.

Referring to FIG. 13, in step S1231, the CPU 111 determines whether the binding processing is to be switched to the staple binding process. When the “Staple binding process” key 1104 is pressed in step S1208 (YES in step S1231), the processing proceeds to step S1232. On the other hand, when the “Stapleless binding process” key 1105 is pressed in step S1208 (NO in step S1231), the processing proceeds to step S1236. In step S1236, the CPU 111 switches the binding processing to be set for a job to the stapleless binding process. The CPU 111 further updates the display of the “Stapleless binding process” key 1105 to indicate the selection of the “Stapleless binding process” key 1105. Then, the processing proceeds to step S1209.

In step S1232, the CPU 111 determines whether the setting for using the stapleless binding process instead of the staple binding process is enabled (ON), with reference to the information about the staple alternative processing stored in the storage 114 or the RAM 113. When the CPU 111 determines that the setting for using the stapleless binding process instead of the staple binding process is enabled (YES in step S1232), the processing proceeds to step S1233. On the other hand, when the CPU 111 determines that the setting for using the stapleless binding process instead of the staple binding process is not enabled (disabled) (NO in step S1232), the processing proceeds to step S1237.

In step S1237, the CPU 111 switches the binding processing to be set for a job to the staple binding process. The CPU 111 further updates the display of the “Staple binding process” key 1104 to indicate the selection of the “Staple binding process” key 1104. Then, the processing proceeds to step S1209.

In step S1233, the CPU 111 refer to the remaining amount of staples R stored in the storage 114 or the RAM 113. Then, the CPU 111 determines whether the remaining amount of staples R is equal to or smaller than the threshold value set for the staple alternative processing. When the CPU 111 determines that the remaining amount of staples R is equal to or smaller than the threshold value (YES in step S1233), the processing proceeds to step S1234. On the other hand, when the remaining amount of staples R is larger than the threshold value (NO in step S1233), the processing proceeds to step S1237.

In step S1234, the CPU 111 controls the operation unit 116 to display an inquiry screen for prompting the user to switch the binding processing to the stapleless binding process. FIG. 11B illustrates an example of an inquiry screen.

Information 1113 is used to notify the user of an option for switching the binding processing to the stapleless binding process. When the CPU 111 detects that the remaining amount of staples is zero, the CPU 111 may notify the user that there is no staple and that printing is not possible until the staple cartridge is replaced, instead of the information 1113.

Information 1114 is used to notify the user of the upper-limit number of sheets bindable by the stapleless binding process. A “Change” key 1116 is used when the user intends to switch the binding processing to the stapleless binding process. A “Do Not Change” key 1115 is used when the user does not intend to switch the binding processing to the stapleless binding process (when the user intends to continue the staple binding process).

Referring back to the flowchart illustrated in FIG. 13, in step S1235, the CPU 111 determines which of the keys 1115 and 1116 is pressed. When the CPU 111 determines that the “Change” key 1116 is pressed (CHANGE in step S1235), the processing proceeds to step S1236. On the other hand, when the CPU 111 determines that the “Do Not Change” key 1115 is pressed (DO NOT CHANGE in step S1235), the processing proceeds to step S1237.

In the flowchart illustrated in FIG. 13, when the stapling type is specified, the CPU 111 makes an inquiry to the user about whether to switch the binding processing to the stapleless binding process according to the remaining amount of the staples 1405.

Referring back to the flowchart illustrated in FIG. 12, in step S1214, the CPU 111 determines whether an “OK” key 1112 is pressed. When the CPU 111 determines that the “OK” key 1112 is pressed (YES in step S1214), the processing proceeds to step S1215. On the other hand, when the CPU 111 determines that the “OK” key 1112 is not pressed (NO in step S1214), the processing proceeds to step S1216. In step S1215, the CPU 111 stores the contents set or selected by the user in the RAM 113 as job setting values, and ends the setting of finishing processing. Then, the processing returns to step S1201.

In step S1216, the CPU 111 determines whether the “Cancel Settings” key 1111 is pressed. When the CPU 111 determines that the “Cancel Settings” key 1111 is pressed (YES in step S1216), the processing proceeds to step S1217. On the other hand, when the CPU 111 determines that the “Cancel Settings” key 1111 is not pressed (NO in step S1216), the processing returns to step S1205. The CPU 111 receives finishing settings from the user.

In step S1217, the CPU 111 cancels the contents set or selected by the user and ends setting of finishing processing. Then, the processing returns to step S1201.

In addition to the finishing setting described in steps S1204 to S1217 to the copy job, the user is able to make other settings, for example, a color setting, the magnification setting for copy, the type of two-sided copy selecting, and the number of copies setting (not illustrated).

As described above, in the third exemplary embodiment, if there is a small remaining amount of staples when the user specifies the staple binding process, the CPU 111 can prompt the user to switch the binding processing to the stapleless binding process. Therefore, it is possible to prevent an output operation from being suspended because the remaining amount of staples becomes 0 during execution of the output processing.

Although, in the present exemplary embodiment, copy processing is used as a method for setting the binding processing, as an example, it is not limited thereto. For example, the method is also applicable to a case of setting a default operation of the binding processing in the print function and copy processing provided by the MFP 101.

The image processing apparatus according to the present exemplary embodiment can perform the flowchart illustrated in FIG. 7 according to the first exemplary embodiment and the flowchart illustrated in FIG. 12 according to the second exemplary embodiment. For example, when performing printing based on print data, the image processing apparatus performs the staple alternative processing based on the flowchart illustrated in FIG. 7 or 12. When the binding processing is specified via the operation unit 116, for example, when settings of print data is changed or when settings of copy processing is performed, the image processing apparatus performs processing based on the flowchart illustrated in FIG. 13.

Although, in the first to the third exemplary embodiments, the MFP 101 is provided with the sheet processing unit 122, the present invention is not limited thereto. For example, the first to the third exemplary embodiments are also applicable to a case where the binding processing is performed by using a sheet processing apparatus, having a staple binding unit and a stapleless binding unit, provided as a separate unit and is connected to an image processing apparatus. In this case, the MFP 101 appropriately acquires binding processing capabilities from the relevant separate sheet processing apparatus.

Further, the first to the third exemplary embodiments are also applicable to a case where the user determines in advance whether to perform the staple alternative processing in a print control apparatus such as a PC and a print server instead of the MFP 101. In this case, the PC and the print control apparatus appropriately acquire binding processing capabilities and the remaining amount of staples provided by the MFP 101. In a case of a PC, the stapling processing to be set for the print data may be determined based on the print settings made via a printer driver and the acquired remaining amount of staples. In a case of a print control apparatus, print attributes relating to the binding processing may be changed after analyzing the print data to determine whether the above-described staple alternative processing should be performed.

While the present invention has specifically been described based on the above-described exemplary embodiments, the present invention is not limited thereto, and can be modified in diverse ways within the gist of the appended claims.

According to the present invention, the binding processing is selectively switched according to the remaining amount of consumable materials used for the binding processing. Therefore, even if the remaining amount of consumable materials is zero or small, it is possible to switch to the binding processing without using consumable materials and then perform the binding processing.

### Other Embodiments

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-206741, filed Oct. 7, 2014, which is hereby incorporated by reference herein in its entirety.

What is claimed is:

1. A sheet processing apparatus comprising:
a first binding unit configured to bind sheets by using a consumable material;
a second binding unit configured to bind sheets without using the consumable material; and
a control unit configured to control the sheet processing apparatus to perform binding processing on sheets by using the first or the second binding unit,
wherein the control unit determines whether to perform the binding processing by using the first binding unit or by using the second binding unit according at least to a remaining amount of the consumable material.

2. The sheet processing apparatus according to claim 1, further comprising a holding unit configured to hold the consumable material,
wherein, in a case where the consumable material is held in the holding unit, the control unit controls the sheet processing apparatus to perform the binding processing by using the first binding unit, and
wherein, in a case where the consumable material is not held in the holding unit, the control unit controls the sheet processing apparatus to perform the binding processing by using the second binding unit.

3. The sheet processing apparatus according to claim 2, further comprising a setting unit configured to preset whether the binding processing by using the second binding unit is to be performed in a case where the binding processing by using the first binding unit is specified and the consumable material is not held in the holding unit.

4. The sheet processing apparatus according to claim 2, further comprising an inquiry unit configured to make an inquiry to a user whether to perform the binding processing by using the second binding unit in a case where the binding processing by using the first binding unit is specified and the consumable material is not held in the holding unit.

5. The sheet processing apparatus according to claim 2, further comprising a notification unit configured to make a predetermined notification to a user in a case where the consumable material is not held in the holding unit.

6. The sheet processing apparatus according to claim 1, further comprising a holding unit configured to hold the consumable material,
wherein, in a case where an amount of the consumable materials held in the holding unit is larger than a predetermined threshold value, the control unit controls the sheet processing apparatus to perform the binding processing by using the first binding unit, and
wherein, in a case where the amount of the consumable materials held in the holding unit is smaller than the predetermined threshold value, the control unit controls the sheet processing apparatus to perform the binding processing by using the second binding unit.

7. The sheet processing apparatus according to claim 6, further comprising a setting unit configured to preset whether the binding processing by using the second binding unit is to be performed in a case where the binding processing by using the first binding unit is specified and the remaining amount of the consumable materials held in the holding unit is smaller than the predetermined threshold value.

8. The sheet processing apparatus according to claim 6, further comprising an inquiry unit configured to make an inquiry to a user whether to perform the binding processing by using the second binding unit in a case where the binding processing by using the first binding unit is specified and the remaining amount of the consumable materials held in the holding unit is smaller than the predetermined threshold value.

9. The sheet processing apparatus according to claim 6, wherein, in a case where a number of sheets to be bound is a number of sheets not bindable by the second binding unit, the control unit controls the sheet processing apparatus to perform the binding processing by using the first binding unit even in a case where the amount of the consumable materials held in the holding unit is smaller than the predetermined threshold value.

10. The sheet processing apparatus according to claim 6, further comprising a receiving unit configured to receive the predetermined threshold value from a user.

11. The sheet processing apparatus according to claim 1, further comprising a printing unit configured to print an image on a sheet,
wherein the first and the second binding units perform binding processing on sheets with an image printed thereon by the printing unit.

12. A method for controlling a sheet processing apparatus comprising a first binding unit configured to bind sheets by using a consumable material, and a second binding unit configured to bind sheets without using the consumable material, the method comprising:
controlling the sheet processing apparatus to perform binding processing on sheets by using the first or the second binding unit,
wherein whether to perform the binding processing by using the first binding unit or by using the second binding unit is determined according at least to the remaining amount of the consumable materials.

13. A non-transitory storage medium storing a program for causing a computer to execute a method for controlling a sheet processing apparatus comprising a first binding unit configured to bind sheets by using a consumable material, and a second binding unit configured to bind sheets without using the consumable material, the method comprising:
controlling the sheet processing apparatus to perform binding processing on sheets by using the first or the second binding unit,
wherein whether to perform the binding processing by using the first binding unit or by using the second binding unit is determined according at least to the remaining amount of the consumable materials.
